(19) United States
(12) Patent Application Publication
(10) Pub. No.: US 2005/0237998 A1
(43) Pub. Date: Oct. 27, 2005

(54) Audio decoding apparatus and network telephone set

(76) Inventors: Kozo Okuda, Hirakata City (JP); Mika Kirimoto, Higashiosaka City (JP); Takashi Iida, Hirakata City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/768,187

(22) Filed: Feb. 2, 2004

(30) Foreign Application Priority Data
Feb. 3, 2003 (JP) 2003-026409

(51) Int. Cl. H04L 12/66

(52) U.S. Cl. 370/352

(57) ABSTRACT

An audio decoding apparatus comprises packet order change control means, comprising packet rearranging storage means capable of storing one or a plurality of received packets, for outputting the packet which has been sent out in the earliest time from a transmission side, out of the packet received this time and the packets stored in the packet rearranging storage means, on the basis of order information related to the received packet and order information related to the packets stored in the packet rearranging storage means as well as storing in the packet rearranging storage means the packets excluding the outputted packet out of the received packet and the packets stored in the packet rearranging storage means; and an FIFO jitter buffer for sequentially storing the packets outputted from the packet order change control means as well as outputting the stored packets in the order inputted.

### BACKGROUND OF THE INVENTION

1. Field of the Invention

The present invention relates to a network telephone set and an audio decoding apparatus that utilize VoIP of an Internet telephone set or the like.

2. Description of the Background Art

For example, Internet telephone that carries out audio telephone conversations using the Internet has already been developed. The Internet telephone utilizes techniques called “VoIP”. VoIP (Voice over Internet Protocol) is a technique that makes it possible to carry out audio telephone conversations on an IP network such as the Internet or the intranet, that is, to transmit and receive audio data.

The Internet telephone compresses an audio and then, packetizes the compressed audio, to carry out telephone conversations via an IP network, unlike conventional telephone sets. In this type of telephone conversation device, a variation (jitter) may occur in the times when packets arrive in many cases depending on the conditions of the IP network. That is, intervals of the packets which arrive via the IP network may not be fixed in many cases. In order to continuously output a decoded audio on the side of the receiving of the packets, however, coded data must be delivered to a decoder at predetermined intervals. Therefore, a jitter buffer 101 for absorbing the jitter is provided in the preceding stage of a decoder 102, as shown in FIG. 1.

The jitter buffer 101 comprises a plurality of buffer portions for respectively storing a plurality of packets. The packets which have arrived are stored in the order of their packet numbers from the left in the buffer portions in the jitter buffer 101 in accordance with order information stored in the packets. The packet stored in the buffer portion on the leftmost side is read out for each predetermined time period, and is delivered to the decoder 102. When one of the packets is delivered to the decoder 102, the other packets in the jitter buffer 101 are shifted one at a time leftward. The decoder 102 decodes the packet (coded data) delivered from the jitter buffer 101, and outputs the decoded packet.

The jitter buffer requires the function of rearranging the received packets which arrive in a rearranged state in the correct order in addition to a buffering function for outputting the received packets at predetermined intervals. However, a circuit for simultaneously realizing the processing becomes significantly complicated in configuration.

The buffering function is efficient if it is realized in an FIFO (first in first out) form in which received packets can be outputted at predetermined intervals in the order in which they arrive. Accordingly, it is considered that an FIFO jitter buffer (FIFO memory) is used as the jitter buffer. When the FIFO jitter buffer is used as the jitter buffer, however, the received packets which arrive in a rearranged state cannot be rearranged in the correct order in the FIFO jitter buffer.

### SUMMARY OF THE INVENTION

An object of the present invention is to provide, in an audio decoding apparatus using as a jitter buffer an FIFO jitter buffer capable of efficiently realizing a buffering function, an audio decoding apparatus capable of rearranging received packets which arrive in a rearranged state in the order which is as correct as possible before the received packets are stored in the FIFO jitter buffer.

Another object of the present invention is to provide, in a network telephone set using as a jitter buffer an FIFO jitter buffer capable of efficiently realizing a buffering function, a network telephone set capable of rearranging received packets which arrive in a rearranged state in the order which is as correct as possible before the received packets are stored in the FIFO jitter buffer.

In an audio decoding apparatus comprising an FIFO jitter buffer as a jitter buffer, a first audio decoding apparatus according to the present invention is characterized by comprising packet order change control means, comprising packet rearranging storage means capable of storing one or a plurality of received packets, for outputting the packet which has been sent out in the earliest time from a transmission side, out of the packet received this time and the packets stored in the packet rearranging storage means, on the basis of order information related to the received packet and order information related to the packets stored in the packet rearranging storage means as well as storing in the packet rearranging storage means the packets excluding the outputted packet out of the received packet and the packets stored in the packet rearranging storage means; an FIFO jitter buffer for sequentially storing the packets outputted from the packet order change control means as well as outputting the stored packets in the order inputted; and decoding means for decoding the packet outputted from the FIFO jitter buffer.

An example of the packet order change control means is one comprising packet rearranging storage means capable of storing one or a plurality of received packets, means for specifying, on the basis of the order information related to the packet received this time and the order information related to the packets stored in the packet rearranging storage means, the packet sent out in the earliest time from the transmission side out of the packets, means for outputting, when the packet sent out in the earliest time is the packet received this time, the packet received this time, and means for outputting, when the packet sent out in the earliest time is the packet stored in the packet rearranging storage means, the packet sent out in the earliest time, as well as storing in the packet rearranging storage means the packet received this time and the packets excluding the outputted packet out of the packets stored in the packet rearranging storage means.

The packet order change control means may comprise a plurality of packet order change control means, the packet order change control means may be connected in series, and the packet outputted from the packet order change control means in the final stage may be stored in the FIFO jitter buffer.

In an audio decoding apparatus comprising an FIFO jitter buffer as a jitter buffer, a second audio decoding apparatus according to the present invention is characterized by comprising packet order change control means for controlling the order of received packets; an FIFO jitter buffer for sequentially storing the packets outputted from the packet order change control means as well as outputting the stored packets in the order inputted; and decoding means for decoding the packet outputted from the FIFO jitter buffer, the packet order change control means comprising a plurality of packet rearranging storage means capable of storing a plurality of received packets, first means for outputting the packet first received after initialization processing as well as setting order information related to the outputted packet as order information related to the packet last outputted, second means for storing, when the second and subsequent packets are received after the initialization processing, the packet received this time in the packet rearranging storage means as well as selecting the packet which has been sent out in the earliest time from a transmission side, out of the packets stored in the packet rearranging storage means, third means for judging whether or not the order information related to the selected packet is a number subsequent to the order information related to the packet last outputted, fourth means for outputting, when the order information related to the packet selected by the third means is a number subsequent to the order information related to the packet last outputted, the packet, setting the order information related to the outputted packet as the order information related to the packet last outputted, and setting the packet rearranging storage means which has stored the packet to an empty state, fifth means for storing, when the order information related to the packet selected by the third means is not a number subsequent to the order information related to the packet last outputted, and the packet rearranging storage means is not full, the packet as it is in the packet rearranging storage means, and then waiting until the subsequent packet is received, sixth means for outputting, when the order information related to the packet selected by the third means is not a number subsequent to the order information related to the packet last outputted, and the packet rearranging storage means is full, the packet, setting the order information related to the outputted packet as the order information related to the packet last outputted, and setting the packet rearranging storage means which has stored the packet to an empty state, and seventh means for judging, when processing is performed by the fourth means or the sixth means, whether or not the packet rearranging storage means is empty, and waiting, when the packet rearranging storage means is empty, until the subsequent packet is received, while performing, when the packet rearranging storage means is not empty, processing of the second means and the subsequent means.

In network telephone set comprising an FIFO jitter buffer as a jitter buffer, a first network telephone set according to the present invention is characterized by comprising packet order change control means, comprising packet rearranging storage means capable of storing one or a plurality of received packets, for outputting the packet which has been sent out in the earliest time from a transmission side, out of the packet received this time and the packets stored in the packet rearranging storage means on the basis of order information related to the received packet and order information related to the packets stored in the packet rearranging storage means as well as storing in the packet rearranging storage means the packets excluding the outputted packet out of the received packet and the packets stored in the packet rearranging storage means; an FIFO jitter buffer for sequentially storing the packets outputted from the packet order change control means as well as outputting the stored packets in the order inputted; and decoding means for decoding the packet outputted from the FIFO jitter buffer.

An example of the packet order change control means is one comprising packet rearranging storage means capable of storing one or a plurality of received packets, means for specifying, on the basis of the order information related to the packet received this time and the order information related to the packets stored in the packet rearranging storage means, the packet sent out in the earliest time from the transmission side, out of the packets, means for outputting, when the packet sent out in the earliest time is the packet received this time, the packet received this time, and means for outputting, when the packet sent out in the earliest time is the packet stored in the packet rearranging storage means, the packet sent out in the earliest time, as well as storing in the packet rearranging storage means the packet received this time and the packets excluding the outputted packet out of the packets stored in the packet rearranging storage means.

The packet order change control means may comprise a plurality of packet order change control means, the packet order change control means may be connected in series, and the packet outputted from the packet order change control means in the final stage may be stored in the FIFO jitter buffer.

In a network telephone set comprising an FIFO jitter buffer as a jitter buffer, a second network telephone set according to the present invention is characterized by comprising packet order change control means for controlling the order of received packets; an FIFO jitter buffer for sequentially storing the packets outputted from the packet order change control means as well as outputting the stored packets in the order inputted; and decoding means for decoding the packet outputted from the FIFO jitter buffer, the packet order change control means comprising a plurality of packet rearranging storage means capable of storing a plurality of received packets, first means for outputting the packet first received after initialization processing as well as setting order information related to the outputted packet as order information related to the packet last outputted, second means for storing, when the second and subsequent received packets are received after the initialization processing, the packet received this time in the packet rearranging storage means as well as selecting the packet which has been sent out in the earliest time from a transmission side, out of the packets stored in the packet rearranging storage means, third means for judging whether or not the order information related to the selected packet is a number subsequent to the order information related to the packet last outputted, fourth means for outputting, when the order information related to the packet selected by the third means is a number subsequent to the order information related to the packet last outputted, the packet, setting the order information related to the outputted packet as the order information related to the packet last outputted, and setting the packet rearranging storage means which has stored the packet to an empty state, fifth means for storing, when the order information related to the packet selected by the third means is not a number subsequent to the order information related to the packet last outputted, and the packet rearranging storage means is not full, the packet as it is in the packet rearranging storage means, and then waiting until the subsequent packet is received, sixth means for outputting, when the order information related to the packet selected by the third means is not a number subsequent to the order information related to the packet last outputted, and the packet rearranging storage means is full, the packet, setting the order information related to the outputted packet as the order information related to the packet last outputted, and setting the packet rearranging storage means which has stored the packet to an empty state, and seventh means for judging, when processing is performed by the fourth means or the sixth means, whether or not the packet rearranging storage means is empty, and waiting, when the packet rearranging storage means is empty, until the subsequent packet is received, while performing, when the packet rearranging storage means is not empty, processing of the second means and the subsequent means.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a conventional technique;

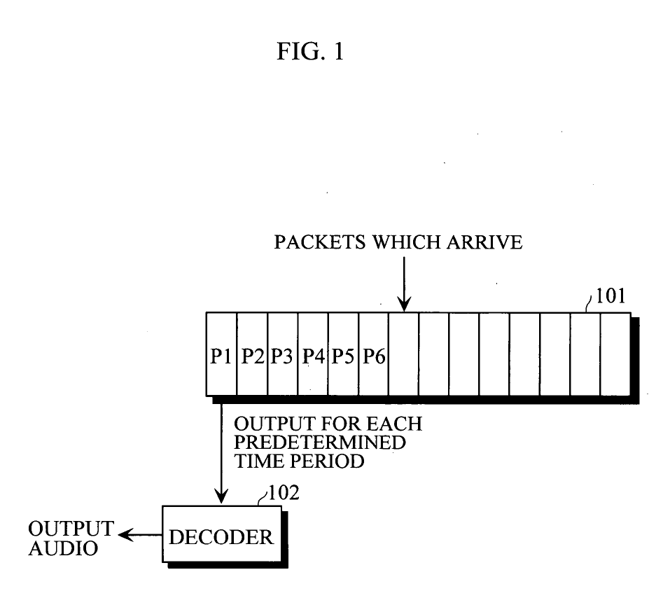

FIG. 2 is a block diagram showing the configuration of an Internet telephone set;

FIG. 3 is a block diagram showing a first example of the configuration of a DSP 3 and a microcomputer 4;

FIG. 4 is a block diagram showing a second example of the configuration of a DSP 3 and a microcomputer 4;

FIG. 5 is a block diagram showing a third example of the configuration of a DSP 3 and a microcomputer 4;

FIGS. 6a to 6f are diagrams for explaining the operation of a packet order change control unit 121;

FIG. 7 is a flow chart showing the procedure for initialization processing by the packet order change control unit 121;

FIG. 8 is a flow chart showing the procedure for packet order change processing by the packet order change control unit 121;

FIG. 9 is a block diagram showing an embodiment in which a packet order change control unit 121 comprises two packet rearranging buffers 120a and 120b;

FIGS. 10a to 10g are diagrams for explaining the operation of the packet order change control unit 121 in a case where there are provided two packet rearranging buffers;

FIG. 11 is a flow chart showing the procedure for packet order change processing by the packet order change control unit 121 in a case where there are provided two packet rearranging buffers;

FIG. 12 is a block diagram showing an embodiment in a case where two packet order change control units are connected in series;

FIGS. 13a to 13f are diagrams for explaining the operation of each of two packet order change control units 121a and 121b in a case where the packet order change control units are connected in series;

FIG. 14 is a flow chart showing the procedure for packet order change processing by the first packet order change control unit 121a;

FIG. 15 is a flow chart showing the procedure for packet order change processing by the second packet order change control unit 121b;

FIGS. 16a to 16f are diagrams for explaining another example of the operation of a packet order change control unit 121;

FIGS. 17a to 17g are diagrams for explaining another example of the operation of the packet order change control unit 121; and

FIG. 18 is a flow chart showing the procedure for packet order change processing explained in FIGS. 16 and 17.

### DESCRIPTION OF THE PREFERRED EMBODIMENT

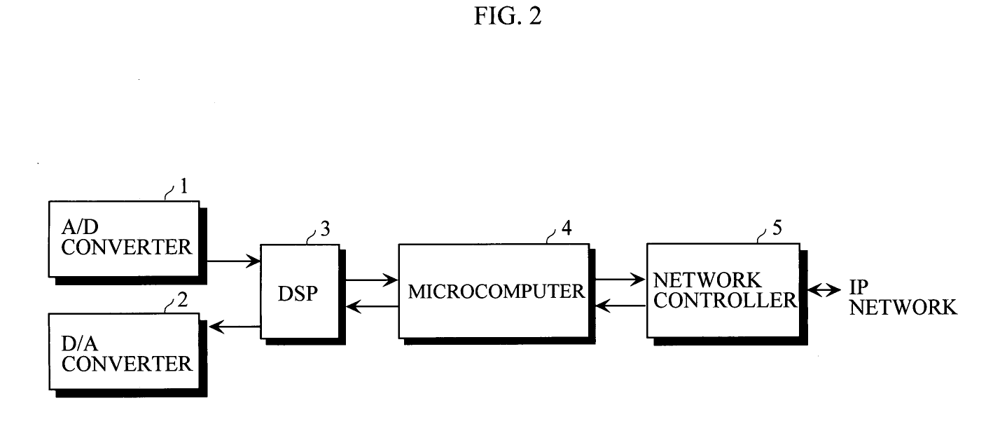

Referring now to FIGS. 2 to 18, description is now made of an embodiment in a case where the present invention is applied to an Internet telephone.

[1] Description of Configuration of Internet Telephone Set

FIG. 2 illustrates the configuration of an Internet telephone set.

The Internet telephone set comprises an A/D (Analog-to-Digital) converter 1, a D/A (Digital-to-Analog) converter 2, a DSP (Digital Signal Processor) 3, a microcomputer 4, and a network controller 5.

An input audio signal is converted into a digital audio signal by the A/D converter 1, and the digital audio signal is then fed to the DSP 3. In the DSP 3, or the DSP 3 and the microcomputer 4, the digital audio signal is compressed, and is then packetized. An obtained packet is sent out to an IP (Internet Protocol) network through the network controller 5.

The packet which has been sent via the IP network is inputted to the microcomputer 4 through the network controller 5. In the microcomputer 4 and the DSP 3, or the DSP 3, the packet is decoded. A digital audio signal obtained by the decoding is converted into an analog audio signal by the D/A converter 2, and the analog audio signal is outputted.

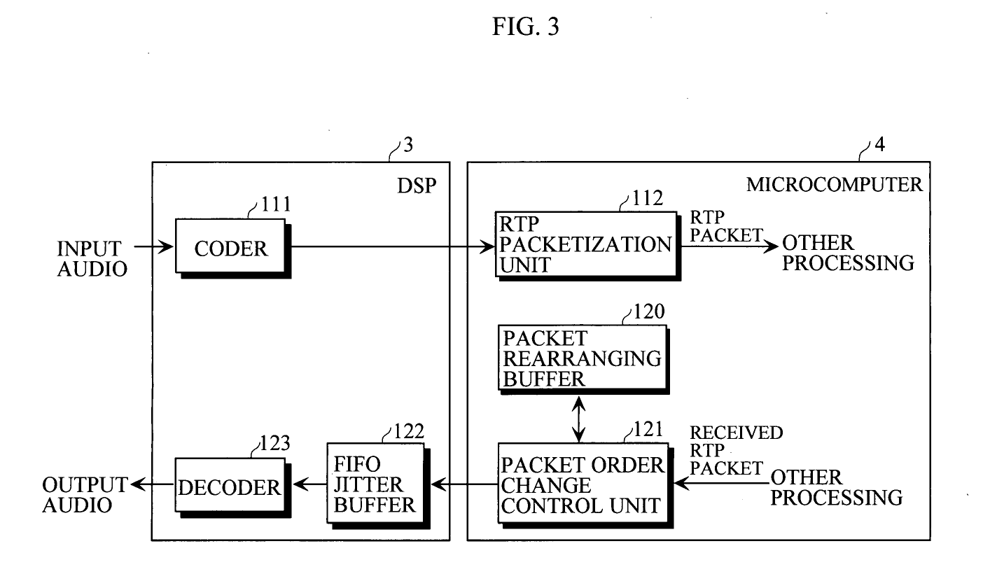

FIGS. 3, 4, and 5 illustrate first, second, and third examples of the configuration of the DSP 3 and the microcomputer 4.

The first example of the configuration shown in FIG. 3 will be first described.

The DSP 3 comprises a coder 111, an FIFO jitter buffer (FIFO memory) 122, and a decoder 123. The microcomputer 4 comprises an RTP (Real Time Transport Protocol) packetization unit 112, a packet order change control unit 121 comprising a packet rearranging buffer (packet rearranging storage means) 120, and so on.

An input audio signal inputted to the DSP 3 from the A/D converter 1 (see FIG. 2) is fed to the coder 111 in the DSP 3. The coder 111 compresses the input audio signal. Coded data obtained by the coder 111 is fed to the RTP packetization unit 112 in the microcomputer 4. The RTP packetization unit 112 packetizes the coded data, to generate an RTP packet. The generated RTP packet is subjected to predetermined processing by the microcomputer 4, and is then sent out to the IP network through the network controller 5 (see FIG. 2).

The received RTP packet which has been sent to the microcomputer 4 through the network controller 5 is subjected to predetermined processing by the microcomputer 4, and is then sent to the packet order change control unit 121 in the microcomputer 4. The packet order change control unit 121 performs packet order change processing, described later, and then sends the received packet to the FIFO jitter buffer 122 in the DSP 3.

The FIFO jitter buffer 122 in the DSP 3 holds the inputted received packet, and outputs the held received packets in the order inputted for each predetermined time interval. The decoder 123 in the DSP 3 decodes the received packet sent from the FIFO jitter buffer 122. An audio signal outputted from the decoder 123 is outputted to the D/A converter 2 (see FIG. 2).

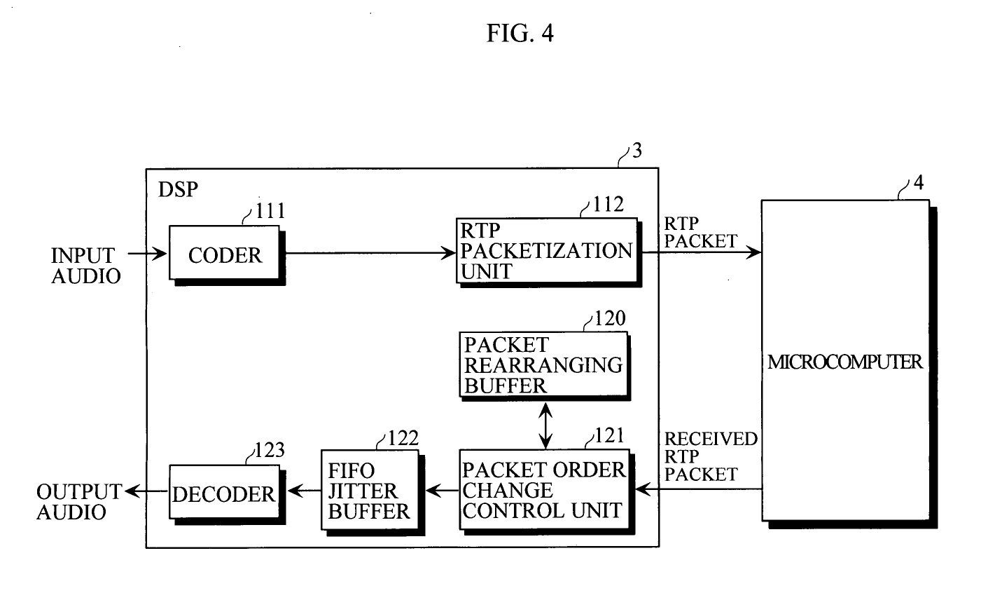

The second example of the configuration shown in FIG. 4 will be then described.

In the example of the configuration shown in FIG. 4, an RTP packetization unit 112 and a packet order change control unit 121, which are provided on the side of the microcomputer 4 in FIG. 3, are provided on the side of the DSP 3. Consequently, a coder 111, the RTP packetization unit 112, the packet order change control unit 121 comprising a packet rearranging buffer 120, an FIFO jitter buffer (FIFO memory) 122, and a decoder 123 are provided in the DSP 3.

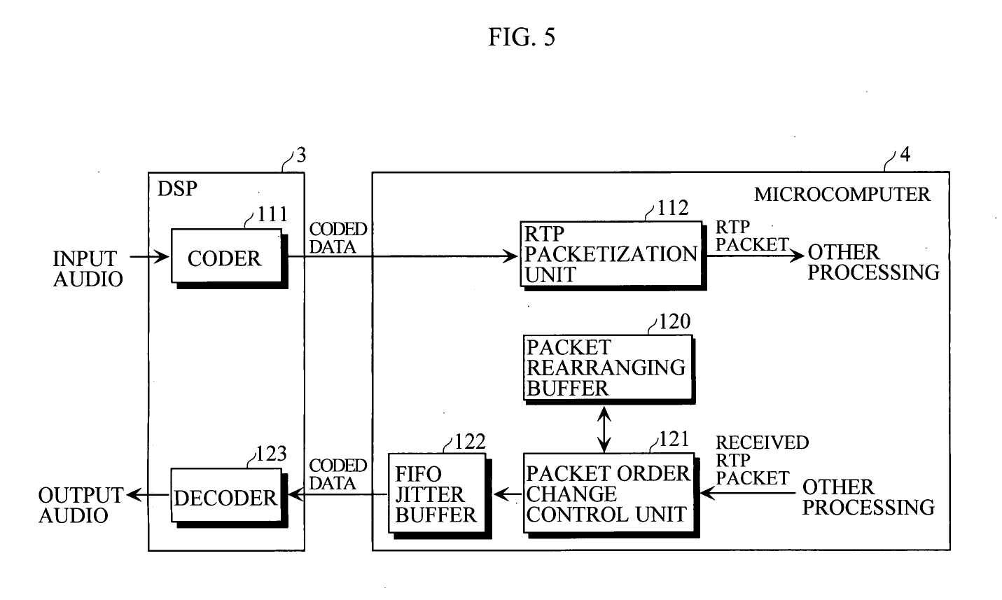

The third example of the configuration shown in FIG. 5 will be then described.

In the example of the configuration shown in FIG. 5, an FIFO jitter buffer (FIFO memory) 122, which is provided on the side of the DSP 3 in FIG. 3, is provided on the side of the microcomputer 4. That is, the DSP 3 comprises a coder 111 and a decoder 123. The microcomputer 4 comprises an RTP packetization unit 112, a packet order change control unit 121 comprising a packet rearranging buffer 120, the FIFO jitter buffer 122, and so on. The example of the configuration of the DSP 3 and the microcomputer 4 is not limited to those shown in FIGS. 3 to 5. For example, another example of the configuration (for example, an RTP packetization unit 112 is provided on the side of the DSP 3 in the example of the configuration shown in FIG. 3).

[2] Description of Operation of Packet Order Change Control Unit 121

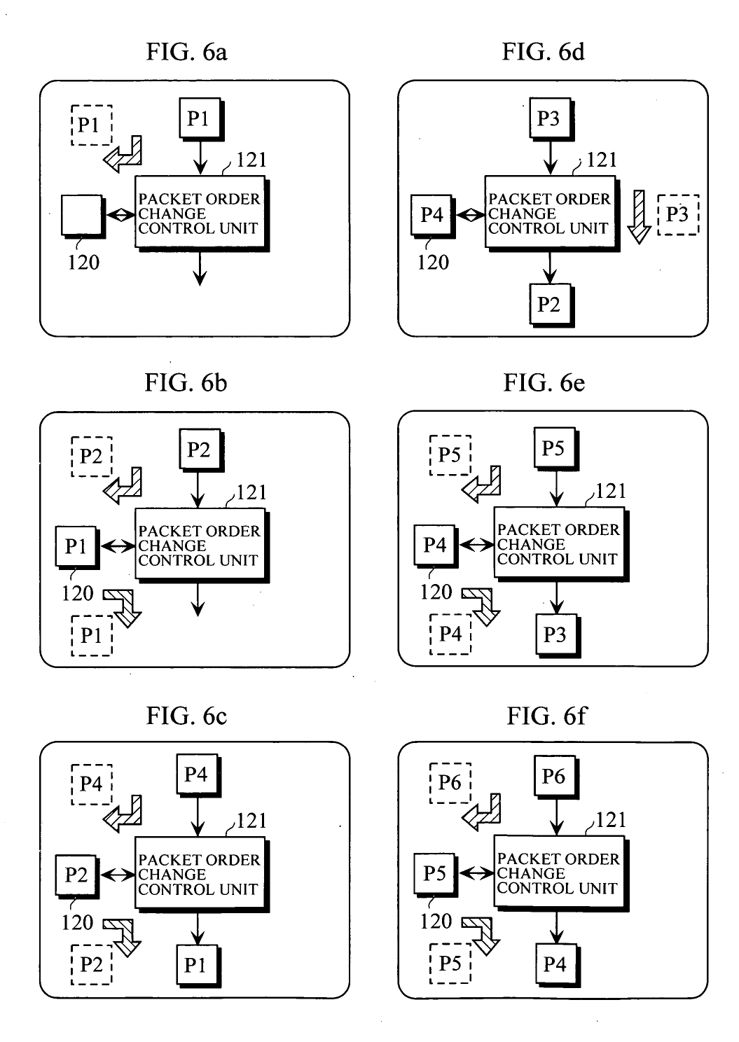

Referring to FIGS. 6a to 6f, description is made of the operation of the packet order change control unit 121. It is herein assumed that there is provided only one packet rearranging buffer 120.

In FIGS. 6a to 6f, Pi (i=1, 2, . . . , 6) represents a received packet, and i represents order information (a sequence number) related to the received packet. P1 is taken as the received packet which has first arrived after initialization processing, described later. The order information related to the received packet indicates the order in which coded data are packetized by the RTP packetization unit 112 and are then transmitted to the IP network, and is included in an RTP header. The order information is represented by a 16-bit variable with no sign (“0” to “FFFF” in hexadecimal notation), and is returned to “0” after it reaches “FFFF”.

As shown in FIG. 6a, when the received packet P1 is first sent after initialization processing, the packet order change control unit 121 stores the received packet P1 in the packet rearranging buffer 120.

As shown in FIG. 6b, when the received packet P2 is then sent, the packet order change control unit 121 compares the order information N (=2) related to the received packet P2 with the order information SN (=1) related to the received packet P1 stored in the packet rearranging buffer 120.

The packet P2 (the order information N (=2)) received this time is transmitted more recently than the received packet P1 (the order information SN (=1)) stored in the packet rearranging buffer 120. Therefore, the received packet P1 stored in the packet rearranging buffer 120 is outputted to the FIFO jitter buffer 122, and the packet P2 received this time is stored in the packet rearranging buffer 120.

As shown in FIG. 6c, when the received packet P4 is then sent, the packet P4 (the order information N (=4)) received this time is transmitted more recently than the packet P2 (the order information SN (=2)) stored in the packet rearranging buffer 120. Therefore, the received packet P2 stored in the packet rearranging buffer 120 is outputted to the FIFO jitter buffer 122, and the packet P4 received this time is then stored in the packet rearranging buffer 120.

As shown in FIG. 6d, when the received packet P3 is then sent, the packet P3 (the order information N (=3)) received this time is transmitted less recently than the packet P4 (the order information SN (=4)) stored in the packet rearranging buffer 120. Therefore, the packet P3 received this time is outputted to the FIFO jitter buffer 122 with the received packet P4 stored in the packet rearranging buffer 120. Consequently, the packets are rearranged.

As shown in FIG. 6e, when the received packet P5 is then sent, the packet P5 (the order information N (=5)) received this time is transmitted more recently than the received packet P4 (the order information SN (=4)) stored in the packet rearranging buffer 120. Therefore, the received packet P4 stored in the packet rearranging buffer 120 is outputted to the FIFO jitter buffer 122, and the packet P5 received this time is then stored in the packet rearranging buffer 120.

As shown in FIG. 6f, when the received packet P6 is then sent, the packet P6 (the order information N (=6)) received this time is transmitted more recently than the packet P5 (the order information SN (=5)) stored in the packet rearranging buffer 120. Therefore, the received packet P5 stored in the packet rearranging buffer 120 is outputted to the FIFO jitter buffer 122, and the packet P6 received this time is then stored in the packet rearranging buffer 120.

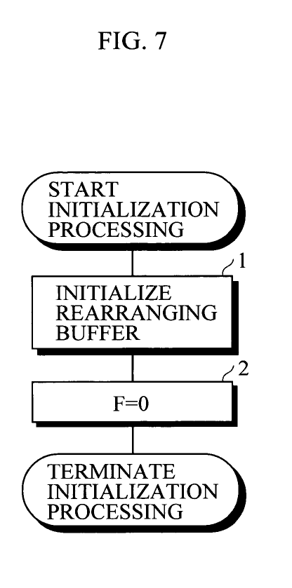

FIG. 7 shows the procedure for initialization processing by the packet order change control unit 121. The initialization processing shown in FIG. 7 is performed in a case where it is judged that a telephone is connected so that a telephone conversation can be carried out and a case where telephone conversation processing is disrupted and reset.

In a case where a telephone is connected so that a telephone conversation can be carried out or a case where telephone conversation processing is disrupted and reset, the packet rearranging buffer 120 is initialized (step 1). Thereafter, the value of a flag F storing the fact that initialization processing has just been performed is set to zero (F=0) (step 2). The current initialization processing is terminated.

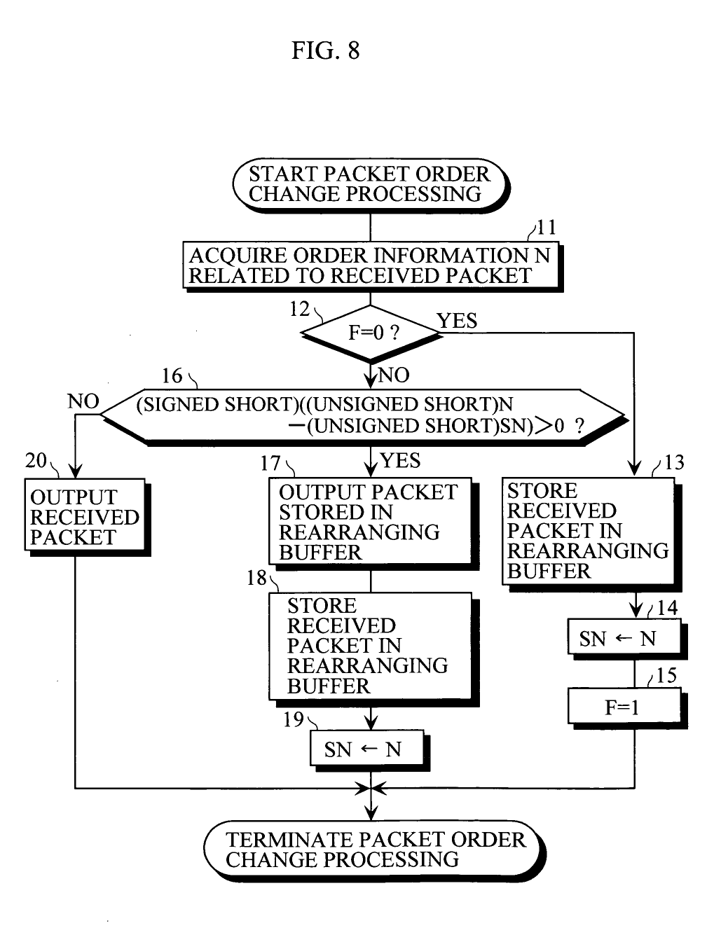

FIG. 8 shows the procedure for packet order change processing by the packet order change control unit 121.

The packet order change processing is performed every time the received packet is sent to the packet order change control unit 121.

When the received packet is sent to the packet order change control unit 121, the order information N related to the received packet is acquired (step 11). N indicates a 16-bit variable (a binary digit) with no sign.

It is judged whether or not the value of the flag F is zero (step 12). If F=0, it is judged that the packet received this time is a received packet which has first arrived after the initialization processing, and the packet received this time is stored in the packet rearranging buffer 120 (step 13). The value of a variable SN representing the order information related to the received packet stored in the packet rearranging buffer 120 is taken as the order information N acquired in the step 11 (step 14). SN indicates a 16-bit variable (a binary digit) with no sign. Further, the value of the flag F is set to one (F=1) (step 15). The current packet order change processing is terminated.

If F=1 in the foregoing step 12, it is judged whether or not the packet received this time is transmitted more recently than the received packet stored in the packet rearranging buffer 120 on the basis of N and SN. Specifically, it is judged whether or not the following expression (1) is satisfied:
(signed short) ((unsigned short)N−(unsigned short)SN)>0 (1)

In the foregoing expression (1), signed short means 16 bits with a sign, and unsigned short means 16 bits with no sign. The left side of the foregoing expression (1) is operated in the following manner. 16-bit subtraction of 16-bit N with no sign and 16-bit SN with no sign, is first done. Specifically, binary addition of a complement to 216 of 16-bit SN with no sign, *SN, to 16-bit N with no sign, i.e., N+*SN, is done. When a carry from the most significant digit is produced as a result of the addition, it is ignored. In such a manner, the obtained 16-bit result of the addition is handled as a 16-bit binary digit with a sign. It is judged whether or not the 16-bit binary number with a sign which is the result of the operation of the left side of the foregoing expression (1) is positive.

Description is made of the reason why such an operation is performed. Actually, even when packets are not received in accordance with the order of transmission, a case where the two packets which are transmitted at very long intervals are hardly rearranged to reach a receiving-side device. It is herein assumed that the packets which are transmitted at intervals of 2¹⁵ or more cannot be rearranged to reach the receiving-side device.

On the premise that the packets which are transmitted at intervals of 2¹⁵ or more cannot be rearranged to reach the receiving-side device, when unsigned short N which is the order information related to the packet received this time is larger than unsigned short SN which is the order information related to the received packet stored in the packet rearranging buffer 120, the most significant digit of the 16-bit binary number with a sign which is the result of the operation of the left side of the foregoing expression (1) is zero, so that it is judged that the binary number is positive with an exception, described later. That is, it is judged that the packet received this time is transmitted more recently than the received packet stored in the packet rearranging buffer 120.

The exception is caused by the fact that the order information related to the packet transmitted subsequently to the packet whose order information is “FFFF (hexadecimal notation)” is returned to “0 (hexadecimal notation)”. Using as a boundary a change point from “FFFF (hexadecimal notation)” to “0 (hexadecimal notation)”, when two packets in the vicinity of both sides of the boundary arrive in the order different from the order of transmission, unsigned short N which is the order information related to the packet received this time is a value close to “FFFF (hexadecimal notation)”, and unsigned short SN which is the order information related to the received packet stored in the packet rearranging buffer 120 is a value close to zero (hexadecimal notation)” (N>SN) and the difference therebetween is not less than 2¹⁵. In such a case, the most significant digit of the 16-bit binary number with a sign which is the result of the operation of the left side of the foregoing expression (1) is one, so that it is judged that the binary number is not positive. That is, it is judged that the packet received this time is transmitted less recently than the received packet stored in the packet rearranging buffer 120.

On the premise that the packets which are transmitted at intervals of 2¹⁵ or more cannot be rearranged to reach the receiving-side device, when unsigned short N which is the order information related to the packet received this time is smaller than unsigned short SN which is the order information related to the received packet stored in the packet rearranging buffer 120, the most significant digit of the 16-bit binary number with a sign which is the result of the operation of the left side of the foregoing expression (1) is one, so that it is judged that the binary number is not positive with an exception, described later. That is, it is judged that the packet received this time is transmitted less recently than the received packet stored in the packet rearranging buffer 120.

The exception is caused by the fact that the order information related to the packet transmitted subsequently to the packet whose order information is “FFFF (hexadecimal notation)” is returned to “0 (hexadecimal notation)”. Using as a boundary a change point from “FFFF (hexadecimal notation)” to “0 (hexadecimal notation)”, when two packets in the vicinity of both sides of the boundary arrive in accordance with the order of transmission, unsigned short N which is the order information related to the packet received this time is a value close to “0 (hexadecimal notation)”, and unsigned short SN which is the order information related to the received packet stored in the packet rearranging buffer 120 is a value close to “FFFF (hexadecimal notation)” (N<SN), and the difference therebetween is not less than 2¹⁵. In such a case, the most significant digit of the 16-bit binary number with a sign which is the result of the operation of the left side of the foregoing expression (1) is one, so that it is judged that the binary number is positive. That is, it is judged that the packet received this time is transmitted more recently than the received packet stored in the packet rearranging buffer 120.

If (signed short) ((unsigned short)N−(unsigned short)SN)>0, the packet received this time is transmitted more recently than the received packet stored in the packet rearranging buffer 120. Therefore, the received packet stored in the packet rearranging buffer 120 is outputted to the FIFO jitter buffer 122 (step 17), and the packet received this time is stored in the packet rearranging buffer 120 (step 18). The value of the variable SN representing the order information related to the received packet stored in the packet rearranging buffer 120 is taken as the order information N acquired in the step 11 (step 19). The current packet order change processing is terminated.

In a case where it is judged in the foregoing step 16 that (signed short) ((unsigned short) N−(unsigned short) SN)<0, the packet received this time is transmitted less recently than the received packet stored in the packet rearranging buffer 120. Therefore, the packet received this times is outputted to the FIFO jitter buffer 122 (step 20). The current packet order change processing is terminated.

In the above-mentioned embodiment, the packets are rearranged only depending on which of the order information related to the packets is larger. Accordingly, all the packets transmitted from the transmission side to the receiving side are not necessarily rearranged in ascending order from the packet sent out in the earliest time. When only one packet rearranging buffer 120 is provided, the packets P1, P2, P5, P4, P3, and P6, for example, are received in this order, the packets P1, P2, P4, P3, P5, and P6 are outputted in this order from the packet order change control unit 121.

Although the packets can be rearranged such that they are arranged in the more correct order by increasing the number of packet rearranging buffers 120, as described later, all the packets transmitted from the transmission side to the receiving side are not necessarily rearranged in ascending order from the packet sent out in the earliest time.

Meanwhile, in actual communication, it is not ensured that the packet transmitted from the transmission side can be inevitably received on the received side, so that a packet loss may, in some cases, occur. When it is assumed that all the packets transmitted from the transmission side are rearranged in the order from the least recently transmitted packet to the most recently transmitted packet, therefore, processing is delayed when a packet loss or the like occurs, so that a telephone conversion cannot be carried out. In the present embodiment, therefore, the packets are rearranged only depending on which of the order information related to the packets is larger, thereby preventing processing from being delayed when a packet loss or the like occurs.

[3] Description of Operation of Packet Order Change Control Unit 121 in Case where a Plurality of Packet Rearranging Buffers are Provided

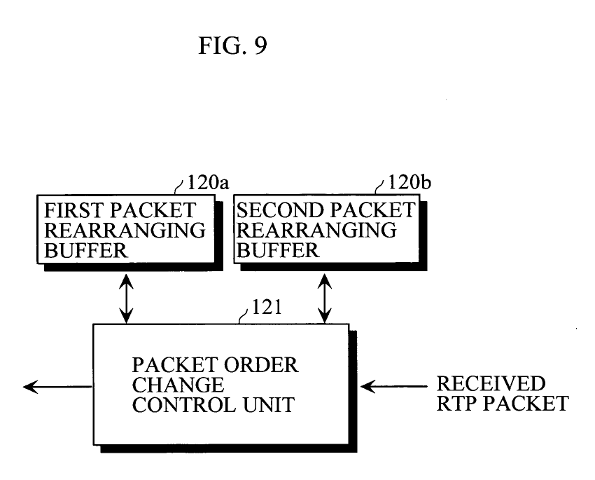

Description is herein made of the operation of the packet order change control unit 121 in a case where the packet order change control unit 121 comprises two packet rearranging buffers 120a and 120b, as shown in FIG. 9.

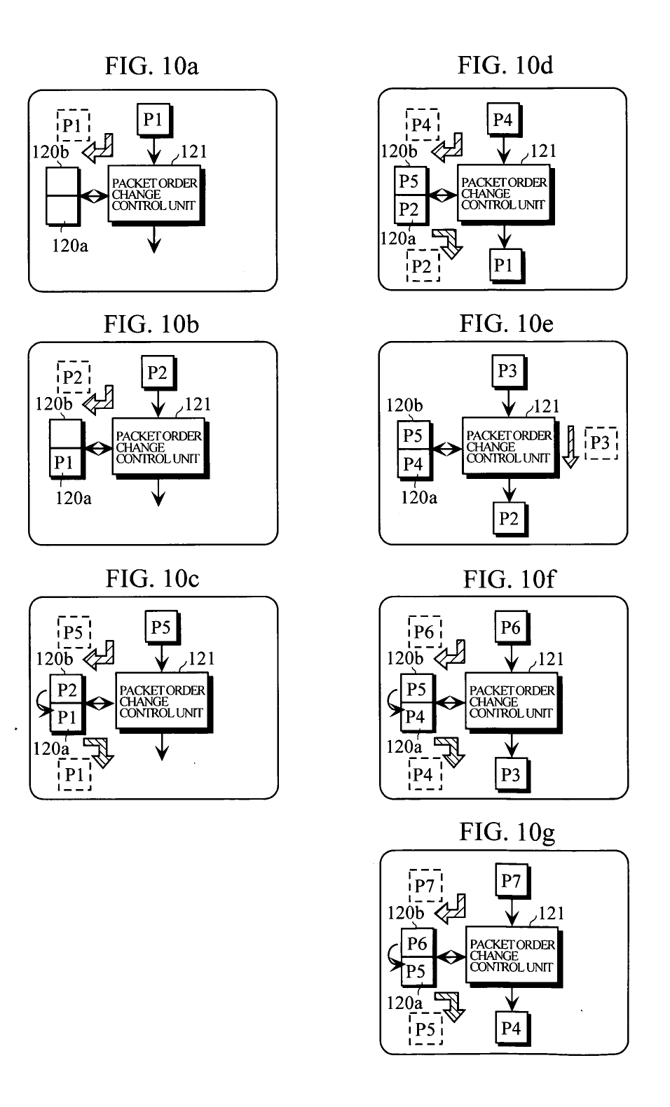

Referring to FIGS. 10a to 10g, description is made of the operation of the packet order change control unit 121 in a case where there are provided two packet rearranging buffers.

One of the two packet rearranging buffers is referred to as a first packet rearranging buffer 120a, and the other packet rearranging buffer is referred to as a second packet rearranging buffer 120b.

In FIGS. 10a and 10g, Pi (i=1, 2, . . . , 7) represents a received packet, and i represents order information related to the received packet. P1 is taken as the received packet which has first arrived after the above-mentioned initialization processing.

As shown in FIG. 10a, when the received packet P1 is first sent after the initialization processing, the packet order change control unit 121 stores the received packet P1 in the first packet rearranging buffer 120a.

As shown in FIG. 10b, when the second received packet P2 is sent after the initialization processing, the packet order change control unit 121 stores the received packet P2 in the second packet rearranging buffer 120b.

As shown in FIG. 10c, when the received packet P5 is then sent, the order information N (=5) related to the packet P5 received this time and the order information SN2 (=2) related to the received packet P2 stored in the second packet rearranging buffer 120b are compared with each other.

The packet. P5 (the order information N (=5)) received this time is transmitted more recently than the received packet P2 (the order information SN2 (=2)) stored in the second packet rearranging buffer 120b. Therefore, the received packet P1 stored in the first packet rearranging buffer 120a is outputted to the FIFO jitter buffer 122. Further, the received packet P2 stored in the second packet rearranging buffer 120b is stored in the first packet rearranging buffer 120a, and the packet P5 received this time is then stored in the second packet rearranging buffer 120b.

As shown in FIG. 10d, when the received packet P4 is then sent, the order information N (=4) related to the packet P4 received this time and the order information SN2 (=5) related to the received packet P5 stored in the second packet rearranging buffer 120b are compared with each other.

The packet P4 (the order information N (=4)) received this time is transmitted less recently than the received packet P5 (the order information SN2 (=5)) stored in the second packet rearranging buffer 120b. Therefore, the received packet P5 is stored as it is in the second packet rearranging buffer 120b.

The order information N (=4) related to the received packet P4 received this time and the order information SN1 (=2) related to the received packet P2 stored in the first packet rearranging buffer 120a are compared with each other. The packet P4 (the order information N (=4)) received this time is transmitted more recently than the received packet P2 (the order information SN1 (=2)) stored in the first packet rearranging buffer 120a. Therefore, the received packet P2 stored in the first packet rearranging buffer 120a is outputted to the FIFO jitter buffer 122, and the packet P4 received this time is then stored in the first packet rearranging buffer 120a.

As shown in FIG. 10e, when the received packet P3 is then sent, the packet P3 (the order information N (=3)) received this time is transmitted less recently than the received packet P5 (the order information SN2 (=5)) stored in the second packet rearranging buffer 120b. Therefore, the received packet P5 is stored as it is in the second packet rearranging buffer 120b.

The packet P3 (the order information N (=3)) received this time is transmitted less recently than the received packet P4 (the order information SN1 (=4)) stored in the first packet rearranging buffer 120a. Therefore, the received packet P4 is stored as it is in the first packet rearranging buffer 120a, and the packet P3 received this time is outputted to the FIFO jitter buffer 122.

As shown in FIG. 10f, when the received packet P6 is then sent, the packet P6 (the order information N (=6)) received this time is transmitted more recently than the received packet P5 (the order information SN2 (=5)) stored in the second packet rearranging buffer 120b. Therefore, the received packet P4 stored in the first packet rearranging buffer 120a is outputted to the FIFO jitter buffer 122. Further, the received packet P5 stored in the second packet rearranging buffer 120b is stored in the first packet rearranging buffer 120a, the packet P6 received this time is stored in the second packet rearranging buffer 120b.

As shown in FIG. 10g, when the received packet P7 is then sent, the packet P7 (the order information N (=7)) received this time is transmitted more recently than the received packet P6 (the order information SN2 (=6)) stored in the second packet rearranging buffer 120b. Therefore, the received packet P5 stored in the first packet rearranging buffer 120a is outputted to the FIFO jitter buffer 122. Further, the received packet P6 stored in the second packet rearranging buffer 120b is stored in the first packet rearranging buffer 120a, and the packet P7 received this time is then stored in the second packet rearranging buffer 120b.

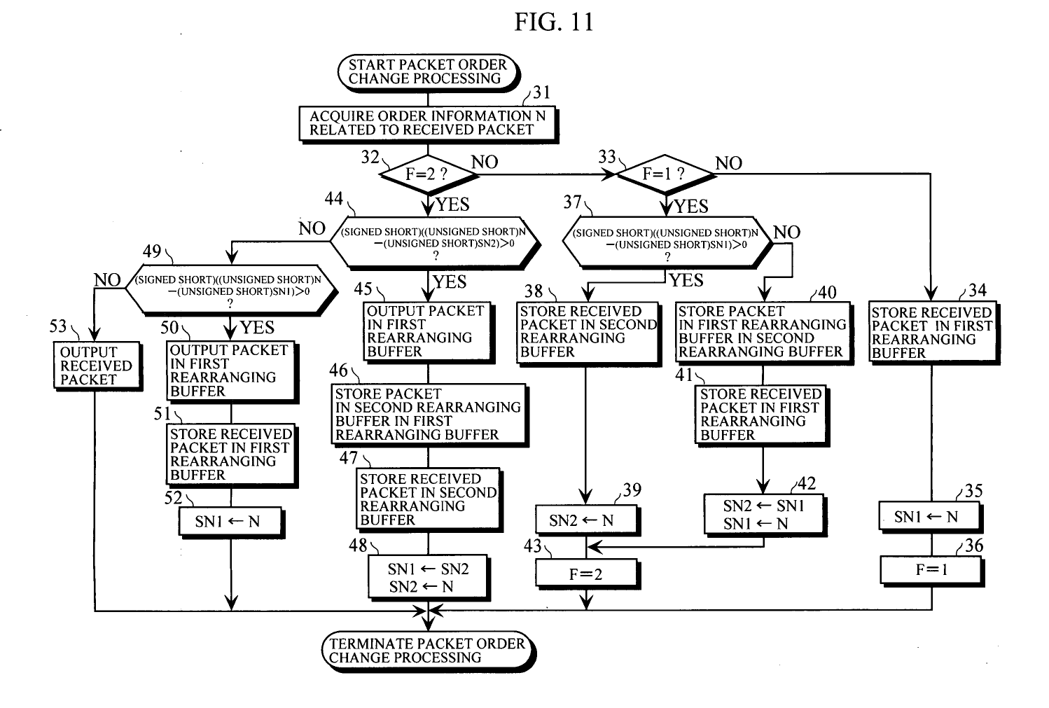

FIG. 11 shows the procedure for packet order change processing by the packet order change control unit 121 in a case where there are provided two packet rearranging buffers. The initialization processing by the packet order change control unit 121 is the same as that shown in FIG. 7.

The packet order change processing is performed every time the received packet is sent to the packet order change control unit 121.

When the received packet is sent to the packet order change control unit 121, the order information N related to the received packet is acquired (step 31).

It is judged whether or not the value of the flag F is two (step 32). Unless F=2, it is judged whether or not the value of the flag F is one (step 33). Unless F=1, F=0. Therefore, it is judged that the packet received this time is a received packet which has first arrived after the initialization processing, and the packet received this time is stored in the first packet rearranging buffer 120a (step 34). The value of a variable SN1 representing the order information related to the received packet stored in the first packet rearranging buffer 120a is taken as the order information N acquired in the step 31 (step 35). Further, the value of the flag F is set to one (F=1) (step 36). The current packet order change processing is terminated.

In a case where it is judged in the foregoing step 33 that F=1, it is judged that the packet received this time is a received packet which has arrived second after the initialization processing, to judge whether or not (signed short) ((unsigned short)N−(unsigned short) SN1)>0 (step 37). If (signed short) ((unsigned short)N−(unsigned short) SN1)>0, the packet received this time is stored in the second packet rearranging buffer 120b (step 38). The value of a variable SN2 representing the order information related to the received packet stored in the second packet rearranging buffer 120b is taken as the order information N acquired in the step 31 (step 39). Further, the value of the flag F is set to two (F=2) (step 43). The current packet order change processing is terminated.

In a case where it is judged in the foregoing step 37 that (signed short) ((unsigned short)N−(unsigned short)SN1)≦0, the received packet stored in the first packet rearranging buffer 120a is stored in the second packet rearranging buffer 120b (step 40). Further, the packet received this time is stored in the first packet rearranging buffer 120a (step 41). The value of the variable SN2 is taken as the value of the variable SN1, and the value of the variable SN1 is taken as the order information N acquired in the step 31 (step 42). Further, the value of the flag F is set to two (F=2) (step 43). The current packet order change processing is terminated.

In a case where it is judged in the foregoing step 32 that F=2, it is judged that the packet received this time is a received packet which has arrived third and later after the initialization processing, to judge whether or not (signed short) ((unsigned short)N−(unsigned short) SN2)>0 (step 44). If (signed short) ((unsigned short)N−(unsigned short) SN2)>0, the received packet stored in the first packet rearranging buffer 120a is outputted to the FIFO jitter buffer 122 (step 45). Further, the received packet stored in the second packet rearranging buffer 120b is stored in the first packet rearranging buffer 120a (step 46), and the packet received this time is then stored in the second packet rearranging buffer 120b (step 47).

The value of the variable SN1 is taken as the value of the variable SN2, and the value of the variable SN2 is taken as the order information N acquired in the step 31 (step 48). The current packet order change processing is terminated.

In a case where it is judged in the foregoing step 44 that (signed short) ((unsigned short) N−(unsigned short) SN2)≦0, it is judged whether or not (signed short)((unsigned short)N−(unsigned short)SN1)>0 (step 49). If (signed short) ((unsigned short)N−(unsigned short)SN1)>0, the received packet stored in the first packet rearranging buffer 120a is outputted to the FIFO jitter buffer 122 (step 50). Further, the packet received this time is stored in the first packet rearranging buffer 120a (step 51). The value of the variable SN1 is taken as the order information N acquired in the step 31 (step 52). The current packet order change processing is terminated.

In a case where it is judged in the foregoing step 49 that (signed short) ((unsigned short)N−(unsigned short) SN1)≦0, the packet received this time is outputted to the FIFO jitter buffer 122 (step 53). The current packet order change processing is terminated.

Although in the example shown in FIG. 9, two packet rearranging buffers are provided in one packet order change control unit, three or more packet rearranging buffers may be provided in one packet order change control unit.

[4] Description of Embodiment in Case Where Plurality of Packet Order Change Control Units are Connected in Series

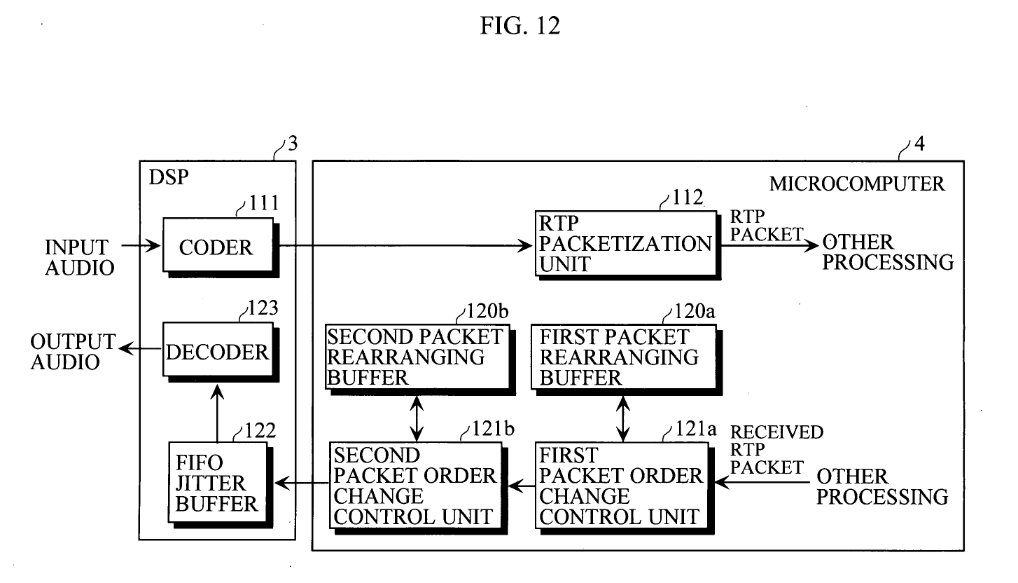

The configuration of an Internet telephone set is the same as that shown in FIG. 2. FIG. 12 illustrates an example of the configuration of a DSP 3 and a microcomputer 4. In FIG. 12, the same units as those shown in FIG. 3 are assigned same reference numerals and hence, the description thereof is not repeated.

The DSP 3 comprises a coder 111, an FIFO jitter buffer (FIFO memory) 122, and a decoder 123, similarly to the DSP 3 shown in FIG. 3.

The microcomputer 4 comprises an RTP packetization unit 112, and two packet order change control units 121a and 121b. The two packet order change control units 121a and 121b are connected in series. In this example, the packet order change control unit 121a in the preceding stage is referred to as a first packet order change control unit 121a, and the packet order change control unit 121b in the succeeding stage is referred to as a second packet order change control unit 121b.

The first packet order change control unit 121a comprises a first packet rearranging buffer 120a. The second packet order change control unit 121b comprises a second packet rearranging buffer 120b.

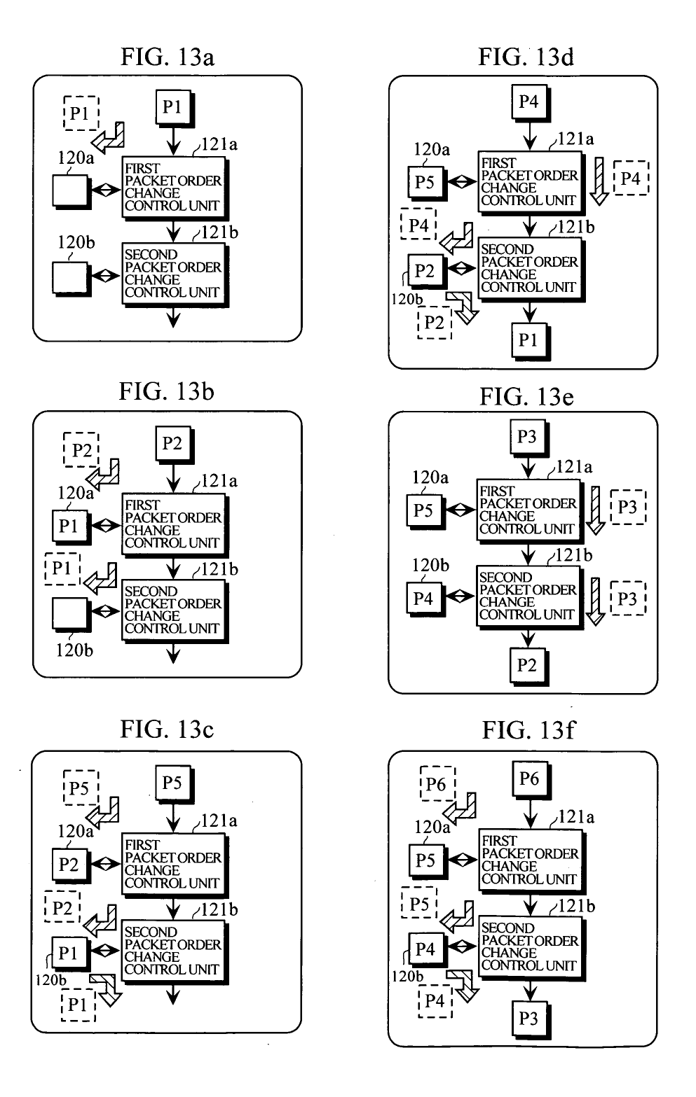

Referring to FIGS. 13a to 13f, description is made of the operation of each of the packet order change control units 121a and 121b.

In FIGS. 13a to 13f, Pi (i=1, 2, . . . , 6) represents a received packet, and i represents order information related to the received packet. P1 is taken as the received packet which has first arrived after the above-mentioned initialization processing.

As shown in FIG. 13a, when the received packet P1 is first sent to the first packet order change control unit 121a after the initialization processing, the first packet order change control unit 121a stores the received packet P1 in the first packet rearranging buffer 120a.

As shown in FIG. 13b, when the received packet P2 is then sent to the first packet order change control unit 121a, the first packet order change control unit 121a compares the order information N (=2) related to the received packet P2 with the order information SN1 (=1) related to the received packet P1 stored in the first packet rearranging buffer 120a.

The packet P2 (the order information N (=2)) received this time is transmitted more recently than the received packet P1 (the order information SN1 (=1)) stored in the first packet rearranging buffer 120a. Therefore, the first packet order change control unit 121a outputs the received packet P1 stored in the first packet rearranging buffer 120a to the second packet order change control unit 121b, and then stores the packet P2 received this time in the first packet rearranging buffer 120a.

The second packet order change control unit 121b stores, when it receives the received packet P1 from the first packet order change control unit 121a, the received packet P1 in the second packet rearranging buffer 120b because the packet P1 is a received packet which has been first received after the initialization processing.

As shown in FIG. 13c, when the received packet P5 is then sent to the first packet order change control unit 121a, the first packet order change control unit 121a outputs the received packet P2 (the order information SN1 (=2)) stored in the first packet rearranging buffer 120a to the second packet order change control unit 121b, and then stores the packet P5 (the order information N (=5)) received this time in the first packet rearranging buffer 120a because the packet P5 received this time is transmitted more recently than the packet P2 stored in the first packet rearranging buffer 120a.

The second packet order change control unit 121b compares, when it receives the received packet P2 from the first packet order change control unit 121a, the order information N (=2) related to the received packet P2 with the order information SN2 (=1) related to the received packet P1 stored in the second packet rearranging buffer 120b.

The second packet order change control unit 121b outputs the received packet P1 (the order information SN2 (=1)) stored in the second packet rearranging buffer 120b to the FIFO jitter buffer 122, and then stores the packet P2 (the order information N (=2)) received from the first packet order change control unit 121a in the second packet rearranging buffer 120b because the packet P2 received from the first packet order change control unit 121a is transmitted more recently than the received packet P1 stored in the second packet rearranging buffer 120b.

As shown in FIG. 13d, when the received packet P4 is then sent to the first packet order change control unit 121a, the first packet order change control unit 121a outputs the packet P4 (the order information N (=4)) received this time to the second packet order change control unit 121b with the received packet P5 (the order information SN1 (=5)) stored in the first packet rearranging buffer 120a because the packet P4 received this time is transmitted less recently than the packet P5 stored in the first packet rearranging buffer 120a.

The second packet order change control unit 121b outputs, when it receives the received packet P4 from the first packet order change control unit 121a, the received packet P2 (the order information SN2 (=2)) stored in the second packet rearranging buffer 120b to the FIFO jitter buffer 122, and then stores the packet P4 (the order information N (=4)) received from the first packet order change control unit 121a in the second packet rearranging buffer 120b because the received packet P4 is transmitted more recently than the packet P2 stored in the second packet rearranging buffer 120b.

As shown in FIG. 13e, when the received packet P3 is then sent to the first packet order change control unit 121a, the first packet order change control unit 121a outputs the packet P3 (the order information N (=3)) received this time to the second packet order change control unit 121b with the received packet P5 (the order information SN1 (=5)) stored in the first packet rearranging buffer 120a because the packet P3 received this time is transmitted less recently than the packet P5 stored in the first packet rearranging buffer 120a.

The second packet order change control unit 121b outputs, when it receives the received packet P3 from the first packet order change control unit 121a, the packet P3 (the order information N (=3)) received this time to the FIFO jitter buffer 122 with the received packet P4 (the order information SN2 (=4)) stored in the second packet rearranging buffer 120b because the received packet P3 is transmitted less recently than the received packet P4 stored in the second packet rearranging buffer 120b.

As shown in FIG. 13f, when the received packet P6 is then sent to the first packet order change control unit 121a, the first packet order change control unit 121a outputs the received packet P5 (the order information SN1 (=5)) stored in the first packet rearranging buffer 120a to the second packet order change control unit 121b, and then stores the packet P6 (the order information N (=6)) received this time in the first packet rearranging buffer 120a because the packet P6 received this time is transmitted more recently than the packet P5 stored in the first packet rearranging buffer 120a.

The second packet order change control unit 121b outputs, when it receives the packet P5 (the order information N (=5)) from the first packet order change control unit 121a, the received packet P4 (the order information SN2 (=4)) stored in the second packet rearranging buffer 120b to the FIFO jitter buffer 122, and then stores the packet P5 received from the first packet order change control unit 121a in the second packet rearranging buffer 120b because the received packet P5 is transmitted more recently than the received packet P4 stored in the second packet rearranging buffer 120b.

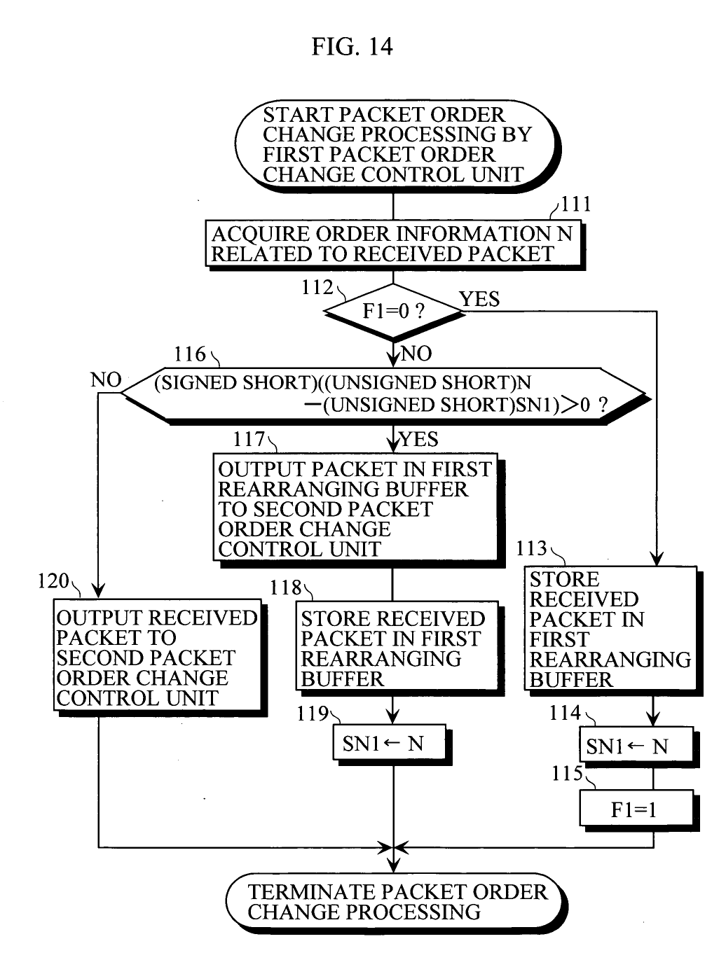

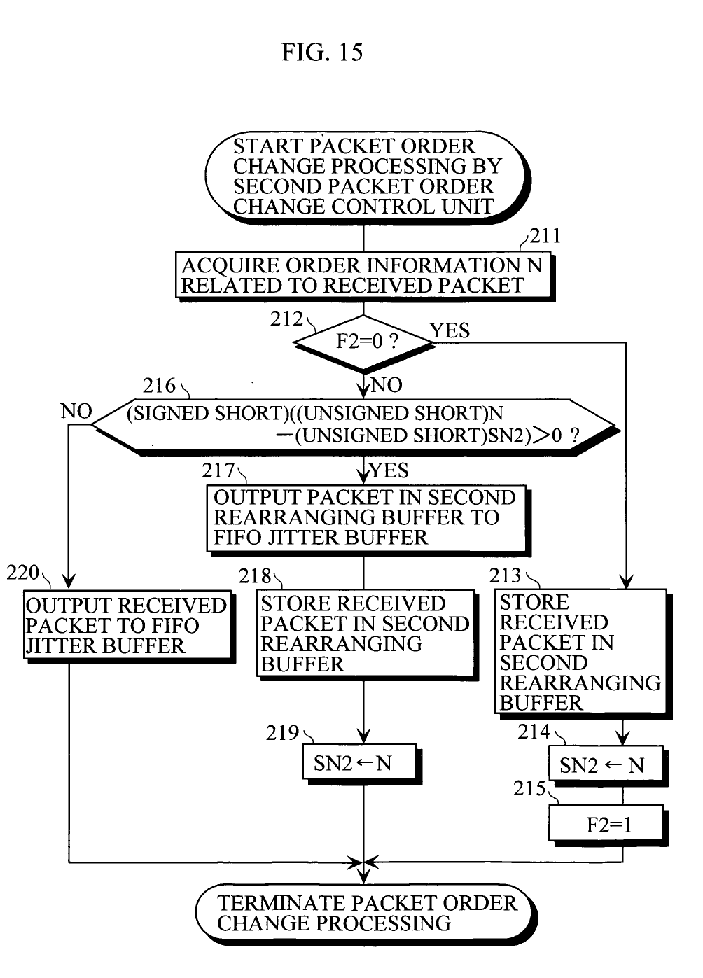

FIG. 14 shows the procedure for packet order change processing by the first packet order change control unit 121a, and FIG. 15 shows the procedure for packet order change processing by the second packet order change control unit 121b.

Initialization processing by the first packet order change control unit 121a and initialization processing by the second packet order change control unit 121b are the same as the initialization processing shown in FIG. 7. In the following description, a flag whose value is made zero by the initialization processing by the first packet order change control unit 121a is taken as F1, and a flag whose value is made zero by the initialization processing by the second packet order change control unit 121b is taken as F2.

Referring to FIG. 14, description is made of the packet order change processing by the first packet order change control unit 121a.

The packet order change processing by the first packet order change control unit 121a is performed every time the received packet is sent to the first packet order change control unit 121a.

When the received packet is sent to the first packet order change control unit 121a, the order information N related to the received packet is acquired (step 111).

It is judged whether or not the value of the flag F1 is zero (step 112). If F1=0, it is judged that the packet received this time is a received packet which has first arrived after the initialization processing, and the packet received this time is stored in the first packet rearranging buffer 120a (step 113). The value of the variable SN1 representing the order information related to the received packet stored in the first packet rearranging buffer 120a is taken as the order information N acquired in the step 111 (step 114). Further, the value of the flag F is set to one (F=1) (step 115). The current packet order change processing is terminated.

If F1=1 in the foregoing step 112, it is judged whether or not (signed short) ((unsigned short)N−(unsigned short) SN1)>0 (step 116). If (signed short)((unsigned short)N−(unsigned short)SN1)>0, the received packet stored in the first packet rearranging buffer 120a is outputted to the second packet order change control unit 121b (step 117), and the packet received this time is stored in the first packet rearranging buffer 120a (step 118). The value of the variable SN1 is taken as the order information N acquired in the step 111 (step 119). The current packet order change processing is terminated.

In a case where it is judged in the foregoing step 116 that (signed short)((unsigned short)N−(unsigned short) SN1)<0, the packet received this time is outputted to the second packet order change control unit 121b (step 120). The current packet order change processing is terminated.

Referring to FIG. 15, description is made of packet order change processing by the second packet order change control unit 121b.

The packet order change processing by the second packet order change control unit 121b is performed every time the received packet is sent to the second packet order change control unit 121b from the first packet order change control unit 121a.

When the received packet is sent to the second packet order change control unit 121b from the first packet order change control unit 121a, the order information N related to the received packet is acquired (step 211).

It is judged whether or not the value of the flag F2 is zero (step 212). If F2=0, it is judged that the packet received this time is a received packet which has first arrived after the initialization processing, and the packet received this time is stored in the second packet rearranging buffer 120b (step 213). The value of the variable SN2 representing the order information related to the received packet stored in the second packet rearranging buffer 120b is taken as the order information N acquired in the step 211 (step 214). Further, the value of the flag F is set to one (F2=1) (step 215). The current packet order change processing is terminated.

If F2=1 in the foregoing step 212, it is judged whether or not (signed short) ((unsigned short)N−(unsigned short) SN2)>0 (step 216). If (signed short)((unsigned short)N−(unsigned short)SN2)>0, the received packet stored in the second packet rearranging buffer 120b is outputted to the FIFO jitter buffer 122 (step 217), and the packet received this time is stored in the second packet rearranging buffer 120b (step 218). The value of the variable SN2 is taken as the order information N acquired in the step 211 (step 219). The current packet order change processing is terminated.

In a case where it is judged in the foregoing step 216 that (signed short) ((unsigned short)N−(unsigned short)SN2)≦0, the packet received this time is outputted to the FIFO jitter buffer 122 (step 220). The current packet order change processing is terminated.

Although in the example shown in FIG. 12, two packet order change control units are connected in series, three or more packet order change control units may be connected in series.

[5] Description of Another Example of Operation of Packet Order Change Control Unit 121

Description is now made of another example of the operation of the packet order change control unit 121.

[5-1] Description of Operation of Packet Order Change Control Unit 121 in Case where Two Packet Rearranging Buffers 120 are Provided

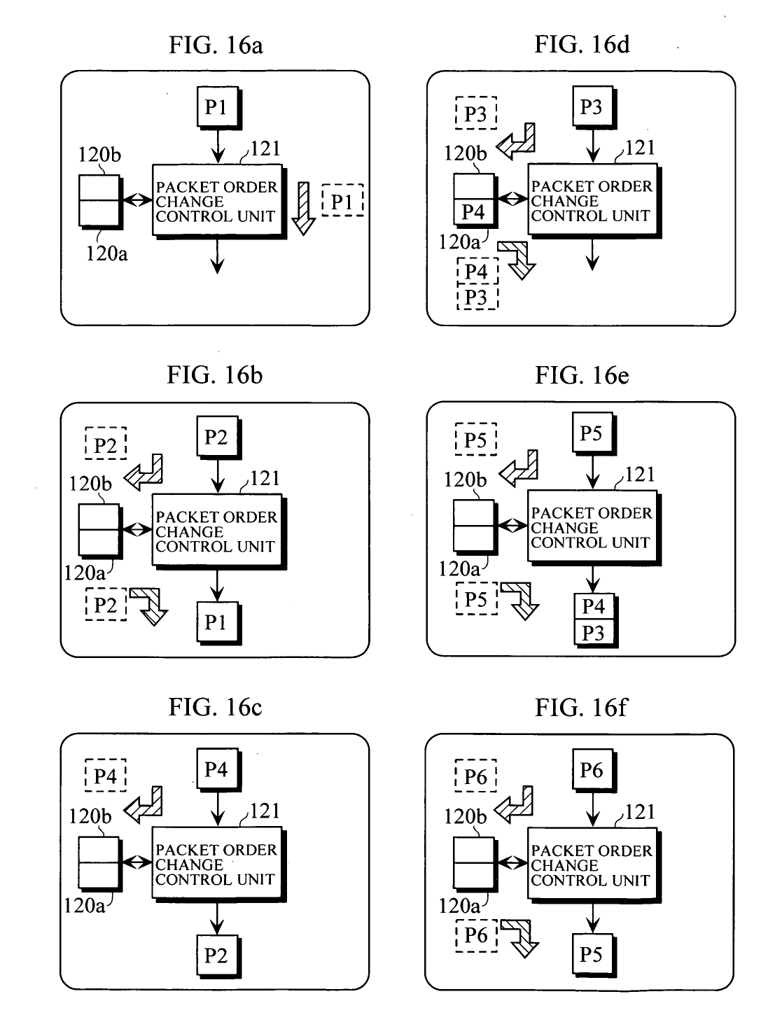

Referring to FIGS. 16a to 16f, description is made of the operation of the packet order change control unit 121. It is herein assumed that the packet order change control unit 121 comprises two packet rearranging buffers 120a and 120b, as shown in FIG. 16.

In FIGS. 16a to 16f, Pi (i=1, 2, . . . , 6) represents a received packet, and i represents order information (a sequence number) related to the received packet. P1 is taken as the received packet which has first arrived after initialization processing, described later. The order information related to the received packet indicates the order in which coded data are packetized by the RTP packetization unit 112 and is then transmitted to the IP network, and is included in an RTP header. The order information is represented by a 16-bit variable with no sign (“0” to “FFFF” in hexadecimal notation), and is returned to “0” after it reaches “FFFF”.

As shown in FIG. 16a, when the received packet (P1 in this example) is first sent after the initialization processing, the packet order change control unit 121 outputs the received packet P1 to the FIFO jitter buffer 122. The order information N (=1) related to the received packet P1 is set as the order information LN related to the packet last outputted to the FIFO jitter buffer 122. That is, LN=1.

As shown in FIG. 16b, when the received packet P2 is then sent, the received packet P2 is stored in the first packet rearranging buffer 120a. It is judged whether or not the order information N (=2) related to the received packet (P2 in this example) which is transmitted least recently out of the packets in the packet rearranging buffers 120a and 120b is a number subsequent to the order information “1” indicated by LN.

The number subsequent to LN means that it is a number which is one larger than LN in principle. When LN=“FFFF”, however, the subsequent number is “0”.

The order information N (=2) related to the received packet P2 which is transmitted least recently out of the packets in the packet rearranging buffers 120a and 120b is a number subsequent to the order information “1” indicated by LN. Therefore, the received packet P2 is outputted to the FIFO jitter buffer 122. When the packet P2 stored in the packet rearranging buffer 120a is thus outputted to the FIFO jitter buffer 122, the packet rearranging buffer 120a which has stored the packet P2 is set to an empty state. The order information N (=2) related to the received packet P2 is set as the order information LN related to the packet last outputted to the FIFO jitter buffer 122. That is, LN=2.

As shown in FIG. 16c, when the received packet P4 is then sent, the received packet P4 is stored in the first packet rearranging buffer 120a. It is judged whether or not the order information N (=4) related to the received packet (P4 in this example) which is transmitted least recently out of the packets in the packet rearranging buffers 120a and 120b is a number subsequent to the order information “2” indicated by LN.

The order information N (=4) related to the received packet P4 which is transmitted least recently out of the packets in the packet rearranging buffers 120a and 120b is not a number subsequent to the order information “2” indicated by LN. Therefore, the received packet P4 remains stored in the first packet rearranging buffer 120a.

As shown in FIG. 16d, when the received packet P3 is then sent, the received packet P3 is stored in the second packet rearranging buffer 120b. It is judged whether or not the order information N (=3) related to the received packet (P3 in this example) which is transmitted least recently out of the packets in the packet rearranging buffers 120a and 120b is a number subsequent to the order information “2” indicated by LN.

The order information N (=3) related to the received packet P3 which is transmitted least recently out of the packets in the packet rearranging buffers 120a and 120b is a number subsequent to the order information “2” indicated by LN. Therefore, the received packet P3 is outputted to the FIFO jitter buffer 122. The order information N (=3) related to the received packet P3 is set as the order information LN related to the packet last outputted to the FIFO jitter buffer 122. That is, LN=3.

Since the received packet P4 is stored in the packet rearranging buffer 120a, the order information N (=4) related to the received packet (P4 in this example) which is transmitted least recently out of the packets in the packet rearranging buffers 120a and 120b is a number subsequent to the order information “3” indicated by LN.

The order information N (=4) related to the received packet P4 which is transmitted least recently out of the packets in the packet rearranging buffers 120a and 120b is a number subsequent to the order information “3” indicated by LN. Therefore, the received packet P4 is outputted to the FIFO jitter buffer 122. The order information N (=4) related to the received packet P4 is set as the order information LN related to the packet last outputted to the FIFO jitter buffer 122. That is, LN=4.

As shown in FIG. 16e, when the received packet P5 is then sent, the received packet P5 is stored in the first packet rearranging buffer 120a. It is judged whether or not the order information N (=5) related to the received packet (P5 in this example) which is transmitted least recently but of the packets in the packet rearranging buffers 120a and 120b is a number subsequent to the order information “4” indicated by LN.

The order information N (=5) related to the received packet P5 which is transmitted least recently out of the packets in the packet rearranging buffers 120a and 120b is a number subsequent to the order information “4” indicated by LN. Therefore, the received packet P5 is outputted to the FIFO jitter buffer 122. The order information N (=5) related to the received packet P5 is set as the order information LN related to the packet last outputted to the FIFO jitter buffer 122. That is, LN=5.

As shown in FIG. 16f, when the received packet P6 is then sent, the received packet P6 is stored in the first packet rearranging buffer 120a. It is judged whether or not the order information N (=6) related to the received packet (P6 in this example) which is transmitted least recently out of the packets in the packet rearranging buffers 120a and 120b is a number subsequent to the order information “5” indicated by LN.

The order information N (=6) related to the received packet P6 which is transmitted least recently out of the packets in the packet rearranging buffers 120a and 120b is a number subsequent to the order information “5” indicated by LN. Therefore, the received packet P6 is outputted to the FIFO jitter buffer 122. The order information N (=6) related to the received packet P6 is set as the order information LN related to the packet last outputted to the FIFO jitter buffer 122. That is, LN=6.

[5-2] Description of Operation of Packet Order Change Control Unit 121 in Case where Three Packet Rearranging Buffers 120 are Provided

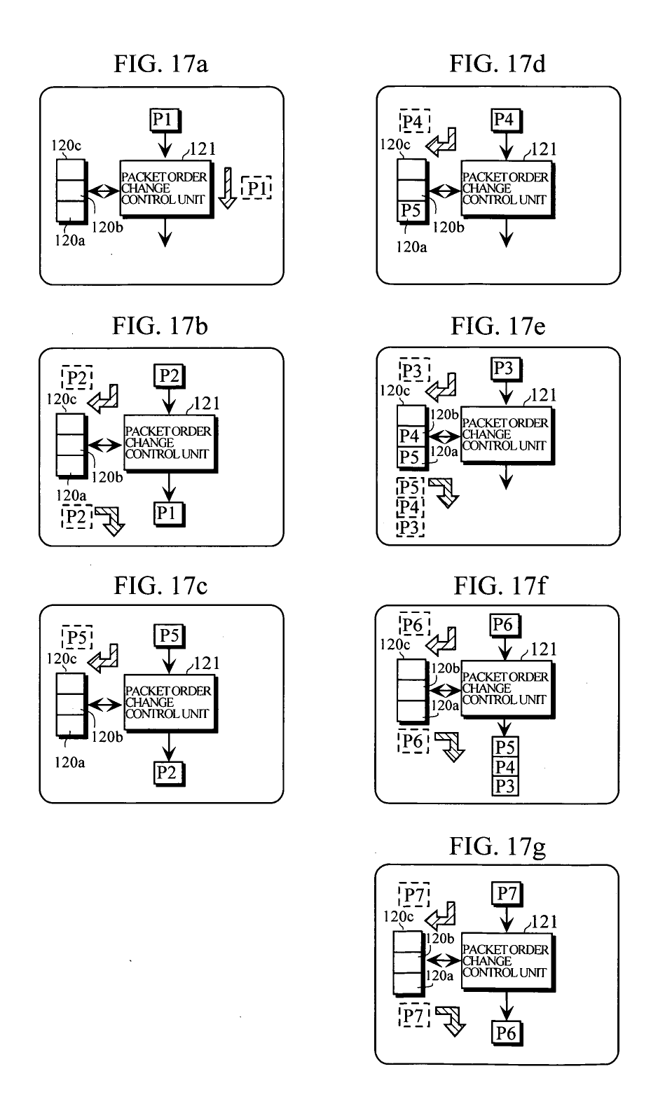

Referring to FIGS. 17a to 17g, description is made of the operation of the packet order change control unit 121. It is herein assumed that the packet order change control unit 121 comprises three packet rearranging buffers 120a, 120b, and 120c, as shown in FIG. 7.

In FIGS. 17a to 17g, Pi (i=1, 2, . . . , 6) represents a received packet, and i represents order information (a sequence number) related to the received packet. P1 is taken as the received packet which has first arrived after initialization processing, described later.

As shown in FIG. 17a, when the received packet (P1 in this example) is first sent after the initialization processing, the packet order change control unit 121 outputs the received packet PI to the FIFO jitter buffer 122. The order information N (=1) related to the received packet P1 is set as the order information LN related to the packet last outputted to the FIFO jitter buffer 122. That is, LN=1.

As shown in FIG. 17b, when the received packet P2 is then sent, the received packet P2 is stored in the first packet rearranging buffer 120a. It is judged whether or not the order information N (=2) related to the received packet (P2 in this example) which is transmitted least recently out of the packets in the packet rearranging buffers 120a, 120b, and 120c is a number subsequent to the order information “1” indicated by LN.

The order information N (=2) related to the received packet P2 which is transmitted least recently out of the packets in the packet rearranging buffers 120a, 120b, and 120c is a number subsequent to the order information “1” indicated by LN. Therefore, the received packet P2 is outputted to the FIFO jitter buffer 122. When the packet P2 stored in the packet rearranging buffer 120a is thus outputted to the FIFO jitter buffer 122, the packet rearranging buffer 120a which has stored the packet P2 is set to an empty state. The order information N (=2) related to the received packet P2 is set as the order information LN related to the packet last outputted to the FIFO jitter buffer 122. That is, LN=2.

As shown in FIG. 17c, when the received packet P5 is then sent, the received packet P5 is stored in the first packet rearranging buffer 120a. It is judged whether or not the order information N (=5) related to the received packet (P5 in this example) which is transmitted least recently out of the packets in the packet rearranging buffers 120a, 120b, and 120c is a number subsequent to the order information “2” indicated by LN.

The order information N (=5) related to the received packet P5 which is transmitted least recently out of the packets in the packet rearranging buffers 120a, 120b, and 120c is not a number subsequent to the order information “2” indicated by LN. Therefore, the received packet P5 remains stored in the first packet rearranging buffer 120a.

As shown in FIG. 17d, when the received packet P4 is then sent, the received packet P4 is stored in the second packet rearranging buffer 120b. It is judged whether or not the order information N (=4) related to the received packet (P4 in this example) which is transmitted least recently out of the packets in the packet rearranging buffers 120a, 120b, and 120c is a number subsequent to the order information “2” indicated by LN.

The order information N (=4) related to the received packet P4 which is transmitted least recently out of the packets in the packet rearranging buffers 120a, 120b, and 120c is not a number subsequent to the order information “2” indicated by LN. Therefore, the received packet P4 remains stored in the second packet rearranging buffer 120b.

As shown in FIG. 17e, when the received packet P3 is then sent, the received packet P3 is stored in the third packet rearranging buffer 120c. It is judged whether or not the order information N (=3) related to the received packet (P3 in this example) which is transmitted least recently out of the packets in the packet rearranging buffers 120a, 120b, and 120c is a number subsequent to the order information “2” indicated by LN.

The order information N (=3) related to the received packet P3 which is transmitted least recently out of the packets in the packet rearranging buffers 120a, 120b, and 120c is a number subsequent to the order information “2” indicated by LN. Therefore, the received packet P3 is outputted to the FIFO jitter buffer 122. The order information N (=3) related to the received packet P3 is set as the order information LN related to the packet last outputted to the FIFO jitter buffer 122. That is, LN=3.

Since the received packets P5 and P4 are respectively stored in the packet rearranging buffer 120a and 120b, the order information N (=4) related to the received packet (P4 in this example) which is transmitted least recently out of the packets in the packet rearranging buffers 120a, 120b, and 120c is a number subsequent to the order information “3” indicated by LN.

The order information N (=4) related to the received packet P4 which is transmitted least recently out of the packets in the packet rearranging buffers 120a, 120b, and 120c is a number subsequent to the order information “3” indicated by LN. Therefore, the received packet P4 is outputted to the FIFO jitter buffer 122. The order information N (=4) related to the received packet P4 is set as the order information LN related to the packet last outputted to the FIFO jitter buffer 122. That is, LN=4.

Since the received packet P5 is stored in the packet rearranging buffer 120a, the order information N (=5) related to the received packet (P5 in this example) which is transmitted least recently out of the packets in the packet rearranging buffers 120a, 120b, and 120c is a number subsequent to the order information “4” indicated by LN.

The order information N (=5) related to the received packet P5 which is transmitted least recently out of the packets in the packet rearranging buffers 120a, 120b, and 120c is a number subsequent to the order information “4” indicated by LN. Therefore, the received packet P5 is outputted to the FIFO jitter buffer 122. The order information N (=5) related to the received packet P5 is set as the order information LN related to the packet last outputted to the FIFO jitter buffer 122. That is, LN=5.

As shown in FIG. 17f, when the received packet P6 is then sent, the received packet P6 is stored in the first packet rearranging buffer 120a. It is judged whether or not the order information N (=6) related to the received packet (P6 in this example) which is transmitted least recently out of the packets in the packet rearranging buffers 120a, 120b, and 120c is a number subsequent to the order information “5” indicated by LN.

The order information N (=6) related to the received packet P6 which is transmitted least recently out of the packets in the packet rearranging buffers 120a, 120b, and 120c is a number subsequent to the order information “5” indicated by LN. Therefore, the received packet P6 is outputted to the FIFO jitter buffer 122. The order information N (=6) related to the received packet P6 is set as the order information LN related to the packet last outputted to the FIFO jitter buffer 122. That is, LN=6.

As shown in FIG. 17g, when the received packet P7 is then sent, the received packet P7 is stored in the first packet rearranging buffer 120a. It is judged whether or not the order information N (=7) related to the received packet (P7 in this example) which is transmitted least recently out of the packets in the packet rearranging buffers 120a, 120b, and 120c is a number subsequent to the order information “6” indicated by LN.

The order information N (=7) related to the received packet P7 which is transmitted least recently out of the packets in the packet rearranging buffers 120a, 120b, and 120c is a number subsequent to the order information “6” indicated by LN. Therefore, the received packet P7 is outputted to the FIFO jitter buffer 122. The order information N (=7) related to the received packet P7 is set as the order information LN related to the packet last outputted to the FIFO jitter buffer 122. That is, LN=7.

[5-3] Description of Procedure for Processing of Packet Order Change Control Unit 121 Explained in FIGS. 16 and 17

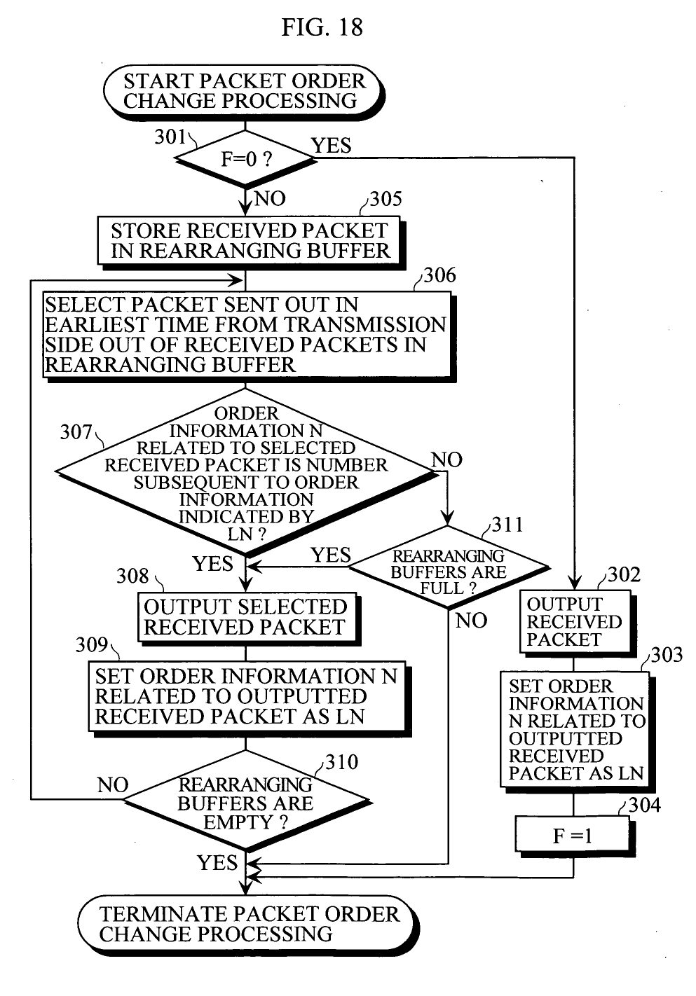

FIG. 18 shows the procedure for packet order change processing described in FIGS. 16 and 17.

The packet order change processing is performed every time the received packet is sent to the packet order change control unit 121.

When the received packet is sent to the packet order change control unit 121, it is judged whether or not the value of the flag F is zero (step 301). If F=0, it is judged that the packet received this time is a received packet which has first arrived after the initialization processing, and the packet received this time is outputted to the FIFO jitter buffer 122 (step 302). The order information N related to the received packet is set as the value of the variable LN representing the order information related to the received packet last outputted to the FIFOjitter buffer 122 (step 303) Further, F=1 (step 304). The current packet order change processing is terminated.

If F=1 in the foregoing step 301, the packet received this time is stored, out of a plurality of provided packet rearranging buffers 120, the empty buffer (step 305).

The received packet which is transmitted least recently out of the received packets stored in the packet rearranging buffers 120 is selected (step 306), and it is judged whether or not the order information N related to the selected received packet is a number subsequent to the order information indicated by LN (step 307).

When the order information N related to the selected received packet is a number subsequent to the order information indicated by LN, the received packet is outputted to the FIFO jitter buffer 122 (step 308). In this case, the packet rearranging buffer 120 which has stored the outputted received packet is set to an empty state. The order information N related to the received packet is set as the value of the variable LN representing the order information related to the received packet last outputted to the FIFO jitter buffer 122 (step 309).

Thereafter, it is judged whether or not all the packet rearranging buffers 120 are empty (step 310). In a case where all the packet rearranging buffers 120 are not empty (a case where the received packet is stored in at least one of the packet rearranging buffers 120), the procedure is returned to the step 306.

In a case where it is judged in the foregoing step 310 that all the packet rearranging buffers 120 are empty, the current packet order change processing is terminated.

In a case where it is judged in the foregoing step 307 that the order information N related to the received packet selected in the step 306 is not a number subsequent to the order information indicated by LN, it is judged whether or not the packet rearranging buffer 120 is full (whether or not the received packet is stored in all the packet rearranging buffers 120) (step 311).

When the packet rearranging buffer 120 is full, the received packet selected in the step 306 is outputted to the FIFO jitter buffer 122 (step 308). The order information N related to the received packet is set as the value of the variable LN representing the order information related to the received packet last outputted to the FIFO jitter buffer 122 (step 309). The procedure proceeds to the step 310.

In a case where it is judged in the foregoing step 311 that all the packet rearranging buffers 120 are not full, that is, a case where at least one of the packet rearranging buffers 120 is empty, the current packet order change processing is terminated.

Although the present invention has been described and illustrated in detail, it is clearly understood that the same is by way of illustration and example only and is not to be taken by way of limitation, the spirit and scope of the present invention being limited only by the terms of the appended claims.

1. In an audio decoding apparatus comprising an FIFO jitter buffer as a jitter buffer,
an audio decoding apparatus comprising:
packet order change control means, comprising packet rearranging storage means capable of storing one or a plurality of received packets, for outputting the packet which has been sent out in the earliest time from a transmission side, out of the packet received this time and the packets stored in the packet rearranging storage means, on the basis of order information related to the received packet and order information related to the packets stored in the packet rearranging storage means as well as storing in the packet rearranging storage means the packets excluding the outputted packet out of the received packet and the packets stored in the packet rearranging storage means;
an FIFO jitter buffer for sequentially storing the packets outputted from the packet order change control means as well as outputting the stored packets in the order inputted; and
decoding means for decoding the packet outputted from the FIFO jitter buffer.

2. The audio decoding apparatus according to claim 1, wherein
the packet order change control means comprises
packet rearranging storage means capable of storing one or a plurality of received packets,
means for specifying, on the basis of the order information related to the packet received this time and the order information related to the packets stored in the packet rearranging storage means, the packet sent out in the earliest time from the transmission side, out of the packets,
means for outputting, when the packet sent out in the earliest time is the packet received this time, the packet received this time, and
means for outputting, when the packet sent out in the earliest time is the packet stored in the packet rearranging storage means, the packet sent out in the earliest time, as well as storing in the packet rearranging storage means the packet received this time and the packets excluding the outputted packet out of the packets stored in the packet rearranging storage means.

3. The audio decoding apparatus according to claim 1, wherein
the packet order change control means comprises a plurality of packet order change control means,
the packet order change control means are connected in series, and
the packet outputted from the packet order change control means in the final stage is stored in the FIFO jitter buffer.

4. The audio decoding apparatus according to claim 2, wherein
the packet order change control means comprises a plurality of packet order change control means,
the packet order change control means are connected in series, and
the packet outputted from the packet order change control means in the final stage is stored in the FIFO jitter buffer.

5. In an audio decoding apparatus comprising an FIFO jitter buffer as a jitter buffer,
an audio decoding apparatus comprising:
packet order change control means for controlling the order of received packets;
an FIFO jitter buffer for sequentially storing the packets outputted from the packet order change control means as well as outputting the stored packets in the order inputted; and
decoding means for decoding the packet outputted from the FIFO jitter buffer,
the packet order change control means comprising
a plurality of packet rearranging storage means capable of storing a plurality of received packets,
first means for outputting the packet first received after initialization processing as well as setting order information related to the outputted packet as order information related to the packet last outputted,
second means for storing, when the second and subsequent packets are received after the initialization processing, the packet received this time in the packet rearranging storage means as well as selecting the packet which has been sent out in the earliest time from a transmission side, out of the packets stored in the packet rearranging storage means,
third means for judging whether or not the order information related to the selected packet is a number subsequent to the order information related to the packet last outputted,
fourth means for outputting, when the order information related to the packet selected by the third means is a number subsequent to the order information related to the packet last outputted, the packet, setting the order information related to the outputted packet as the order information related to the packet last outputted, and setting the packet rearranging storage means which has stored the packet to an empty state,
fifth means for storing, when the order information related to the packet selected by the third means is not a number subsequent to the order information related to the packet last outputted, and the packet rearranging storage means is not full, the packet as it is in the packet rearranging storage means, and then waiting until the subsequent packet is received,
sixth means for outputting, when the order information related to the packet selected by the third means is not a number subsequent to the order information related to the packet last outputted, and the packet rearranging storage means is full, the packet, setting the order information related to the outputted packet as the order information related to the packet last outputted, and setting the packet rearranging storage means which has stored the packet to an empty state, and
seventh means for judging, when processing is performed by the fourth means or the sixth means, whether or not the packet rearranging storage means is empty, and waiting, when the packet rearranging storage means is empty, until the subsequent packet is received, while performing, when the packet rearranging storage means is not empty, processing of the second means and the subsequent means.

6. In a network telephone set comprising an FIFO jitter buffer as a jitter buffer,
a network telephone set comprising:
packet order change control means, comprising packet rearranging storage means capable of storing one or a plurality of received packets, for outputting the packet which has been sent out in the earliest time from a transmission side, out of the packet received this time and the packets stored in the packet rearranging storage means, on the basis of order information related to the received packet and order information related to the packets stored in the packet rearranging storage means as well as storing in the packet rearranging storage means the packets excluding the outputted packet out of the received packet and the packets stored in the packet rearranging storage means;
an FIFO jitter buffer for sequentially storing the packets outputted from the packet order change control means as well as outputting the stored packets in the order inputted; and
decoding means for decoding the packet outputted from the FIFO jitter buffer.

7. The network telephone set according to claim 6, wherein
the packet order change control means comprises
packet rearranging storage means capable of storing one or a plurality of received packets,
means for specifying, on the basis of the order information related to the packet received this time and the order information related to the packets stored in the packet rearranging storage means, the packet sent out in the earliest time from the transmission side, out of the packets,
means for outputting, when the packet sent out in the earliest time is the packet received this time, the packet received this time, and
means for outputting, when the packet sent out in the earliest time is the packet stored in the packet rearranging storage means, the packet sent out in the earliest time, as well as storing in the packet rearranging storage means the packet received this time and the packets excluding the outputted packet out of the packets stored in the packet rearranging storage means.

8. The network telephone set according to claim 6, wherein
the packet order change control means comprises a plurality of packet order change control means,
the packet order change control means are connected in series, and
the packet outputted from the packet order change control means in the final stage is stored in the FIFO jitter buffer.

9. The network telephone set according to claim 7, wherein
the packet order change control means comprises a plurality of packet order change control means,
the packet order change control means are connected in series, and
the packet outputted from the packet order change control means in the final stage is stored in the FIFO jitter buffer.

10. In a network telephone set comprising an FIFO jitter buffer as a jitter buffer,
a network telephone set comprising:
packet order change control means for controlling the order of received packets;
an FIFO jitter buffer for sequentially storing the packets outputted from the packet order change control means as well as outputting the stored packets in the order inputted; and
decoding means for decoding the packet outputted from the FIFO jitter buffer,
the packet order change control means comprising
a plurality of packet rearranging storage means capable of storing a plurality of received packets,
first means for outputting the packet first received after initialization processing as well as setting order information related to the outputted packet as order information related to the packet last outputted,
second means for storing, when the second and subsequent packets are received after the initialization processing, the packet received this time in the packet rearranging storage means as well as selecting the packet which has been sent out in the earliest time from a transmission side, out of the packets stored in the packet rearranging storage means,
third means for judging whether or not the order information related to the selected packet is a number subsequent to the order information related to the packet last outputted,
fourth means for outputting, when the order information related to the packet selected by the third means is a number subsequent to the order information related to the packet last outputted, the packet, setting the order information related to the outputted packet as the order information related to the packet last outputted, and setting the packet rearranging storage means which has stored the packet to an empty state,
fifth means for storing, when the order information related to the packet selected by the third means is not a number subsequent to the order information related to the packet last outputted, and the packet rearranging storage means is not full, the packet as it is in the packet rearranging storage means, and then waiting until the subsequent packet is received,
sixth means for outputting, when the order information related to the packet selected by the third means is not a number subsequent to the order information related to the packet last outputted, and the packet rearranging storage means is full, the packet, setting the order information related to the outputted packet as the order information related to the packet last outputted, and setting the packet rearranging storage means which has stored the packet to an empty state, and
seventh means for judging, when processing is performed by the fourth means or the sixth means, whether or not the packet rearranging storage means is empty, and waiting, when the packet rearranging storage means is empty, until the subsequent packet is received, while performing, when the packet rearranging storage means is not empty, processing of the second means and the subsequent means.
